(19) United States
(12) Patent Application Publication
(10) Pub. No.: US 2014/0298239 A1
(43) Pub. Date: Oct. 2, 2014

(54) STACK STYLE TAB MANAGEMENT

(71) Applicants: John Nicholas Jitkoff, Palo Alto, CA (US); Scott R. Violet, Sunnyvale, CA (US)

(72) Inventors: John Nicholas Jitkoff, Palo Alto, CA (US); Scott R. Violet, Sunnyvale, CA (US)

(73) Assignee: GOOGLE INC., Mountain View, CA (US)

(21) Appl. No.: 13/406,443

(22) Filed: Feb. 27, 2012

Related U.S. Application Data
(60) Provisional application No. 61/496,970, filed on Jun. 14, 2011.

(51) Int. Cl. G06F 3/048

(52) U.S. Cl. 715/777

(57) ABSTRACT

The subject matter of this specification can be implemented in, among other things, a computer-implemented method for managing tabs in a graphical user interface. The method includes receiving a first user input that selects a first tab from among multiple collapsible tabs in a tab area of a tabbed interface. The method further includes determining that the first user input occurs for at least a threshold amount of time. The method further includes expanding the first tab from a collapsed state to an expanded state in response to determining that the first user input occurs for at least the threshold amount of time. The method further includes collapsing a second tab, from among the multiple collapsible tabs, from the expanded state to the collapsed state in response to determining that the first user input occurs for at least the threshold amount of time.

### CROSS-REFERENCE TO RELATED APPLICATIONS

This application claims the benefit of U.S. Provisional Application No. 61/496,970, filed on Jun. 14, 2011, and entitled “Tab Overflow Management,” which is incorporated herein by reference.

### TECHNICAL FIELD

This instant specification relates to managing tabs in a graphical user interface.

### BACKGROUND

A tabbed document interface (TDI) allows multiple documents to be accessed from within a single graphical user interface (GUI). Anachronistically, the tabs in a TDI are based on physical tabs one would use in paper files or card indexes. Each TDI tab, typically aligned along a top edge of a GUI, allows a user to switch to a particular document or page in a set of documents or pages within the GUI. A TDI is commonly used in applications, such as web browsers, text editors, and configuration settings dialogs.

### SUMMARY

In one aspect, a computer-implemented method for managing tabs in a graphical user interface includes receiving a first user input that selects a first tab from among multiple collapsible tabs in a tab area of a tabbed interface. The method further includes determining that the first user input occurs for at least a threshold amount of time. The method further includes expanding the first tab from a collapsed state to an expanded state in response to determining that the first user input occurs for at least the threshold amount of time. The method further includes collapsing a second tab, from among the multiple collapsible tabs, from the expanded state to the collapsed state in response to determining that the first user input occurs for at least the threshold amount of time.

Implementations can include any, all, or none of the following features. The first user input can include a hover operation of a pointer provided by a pointing device. The method can include receiving a second user input that selects a third tab from among the multiple collapsible tabs after receiving the first user input. The second user input can occur for less than the threshold amount of time. The pointer can remain in the tab area between receiving the first user input and receiving the second user input. The second user input can include the hover operation. The method can include expanding the third tab from the collapsed state to the expanded state in response to receiving the second user input. The method can include collapsing the first tab from the expanded state to the collapsed state in response to receiving the second user input. The method can include receiving a third user input that selects a fourth tab from among the multiple collapsible tabs after receiving the second user input. The pointer can leave the tab area between receiving the second user input and receiving the third user input. The third user input can include the hover operation. The method can include determining that the third user input occurs for at least the threshold amount of time. The method can include expanding the fourth tab from the collapsed state to the expanded state in response to determining that the third user input occurs for at least the threshold amount of time. The method can include collapsing the third tab from the expanded state to the collapsed state in response to determining that the third user input occurs for at least the threshold amount of time. At least a portion of each of the multiple collapsible tabs can be displayed in the tab area of the tabbed interface. Collapsing the second tab can occur without collapsing the multiple collapsible tabs other than the second tab. The multiple collapsible tabs can be arranged horizontally and the method can further include sliding one or more of the multiple collapsible tabs horizontally to accommodate collapsing the second tab and expanding the first tab. The tab area can also include one or more non-collapsible tabs that remain in the expanded state. The multiple collapsible tabs can form a first contiguous group of tabs in the tab area and the one or more non-collapsible tabs can form a second contiguous group of tabs in the tab area. The method can include receiving a fourth user input that activates the first tab while the first tab is in the expanded state. The fourth user input can be separate from and of a different type than the first user input. The method can include activating a panel associated with the first tab in response to receiving the fourth user input.

In one aspect, a computer-readable medium storing instructions that when executed cause a computer to perform operations for managing tabs in a graphical user interface that include receiving a first user input that selects a first tab from among multiple collapsible tabs in a tab area of a tabbed interface. The operations further include determining that the first user input occurs for at least a threshold amount of time. The operations further include expanding the first tab from a collapsed state to an expanded state in response to determining that the first user input occurs for at least the threshold amount of time. The operations further include collapsing a second tab, from among the multiple collapsible tabs, from the expanded state to the collapsed state in response to determining that the first user input occurs for at least the threshold amount of time.

Implementations can include any, all, or none of the following features. The first user input can include a hover operation of a pointer provided by a pointing device. At least a portion of each of the multiple collapsible tabs can be displayed in the tab area of the tabbed interface. The operations can further include receiving a second user input that selects a third tab from among the multiple collapsible tabs after receiving the first user input. The second user input can occur for less than the threshold amount of time. The pointer can remain in the tab area between receiving the first user input and receiving the second user input. The second user input can include the hover operation. The operations can include expanding the third tab from the collapsed state to the expanded state in response to receiving the second user input. The operations can include collapsing the first tab from the expanded state to the collapsed state in response to receiving the second user input. The operations can further include receiving a third user input that selects a fourth tab from among the multiple collapsible tabs after receiving the second user input. The pointer can leave the tab area between receiving the second user input and receiving the third user input. The third user input can include the hover operation. The operations can include determining that the third user input occurs for at least the threshold amount of time. The operations can include expanding the fourth tab from the collapsed state to the expanded state in response to determining that the third user input occurs for at least the threshold amount of time. The operations can include collapsing the third tab from the expanded state to the collapsed state in response to determining that the third user input occurs for at least the threshold amount of time. Collapsing the first tab can occur without collapsing the multiple collapsible tabs other than the first tab. The multiple collapsible tabs can be arranged horizontally and the operations can further include sliding one or more of the multiple collapsible tabs horizontally to accommodate collapsing the first tab and expanding the third tab. The tab area can also include one or more non-collapsible tabs that remain in the expanded state. The multiple collapsible tabs can form a first contiguous group of tabs in the tab area and the one or more non-collapsible tabs can form a second contiguous group of tabs in the tab area. The operations can further include receiving a fourth user input that activates the first tab while the first tab is in the expanded state. The fourth user input can be separate from and of a different type than the first user input. The operations can include activating a panel associated with the first tab in response to receiving the fourth user input.

In one aspect, a computer-implemented system for managing tabs in a graphical user interface includes a display device that presents multiple collapsible tabs includes at least a first tab and a second tab, in a tab area of a tabbed interface. The system further includes an interface that receives a first user input that selects the first tab. The system further includes one or more processors that determine that the first user input occurs for at least a threshold amount of time and, in response, expand the first tab from a collapsed state to an expanded state and collapse the second tab from the expanded state to the collapsed state.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example of a system for managing tabs in a graphical user interface.

FIGS. 2A-C show examples of graphical user interfaces for managing tabs in a graphical user interface using a stack style.

FIG. 3 is a flow chart that shows an example of a process for managing tabs in a graphical user interface using a stack style.

FIG. 4 is a schematic diagram that shows an example of a computing device and a mobile computing device.

### DETAILED DESCRIPTION

This document describes systems and techniques for managing tabs in a tabbed document interface (TDI) of a graphical user interface. As each document is opened, a tab is created for the document. A document can be, for example, a word processing file, spreadsheet file, text file, web page, or other working file in a TDI. A user input that activates a tab causes the TDI to present the document associated with the tab in a presentation area of the TDI. In some implementations, one or more of the tabs can include information about the document associated with the tab, such as a title of the document (e.g., a file name or a title of a web page) or a summary of content in the document (e.g., a particular number of unread emails). As more documents are opened the amount of space available to display an individual tab may be reduced. This may limit the amount of information a user can see about the tab.

The GUIs described with respect to the figures below can be, for example, applications running or being executed at a computing device, such as a desktop, laptop, tablet device, or mobile device. In some implementations, the GUIs may be accessed using input/output devices such as a pointing device (e.g., a mouse, track ball, touchpad, or touch display) and a keyboard (e.g., a physical keyboard or a soft keyboard). The applications can be, for example, web browsers and/or other applications where multiple documents or working files are currently open or referenced with the application.

The application and corresponding tabs may be implemented using multiple processes at the computing device. For example, each tab may be implemented in a separate process and together the tabs give the appearance of a single cohesive application to the user. Multiple methods can be used to manage tabs where the amount of space occupied by the tabs when fully expanded is larger than the screen space available for displaying the tabs. In general, the application can receive a user input that selects a tab or group of tabs for expansion. In response to receiving the user input, the application expands the selected tab or group of tabs, and reduces or collapses one or more other tabs that were not selected for expansion.

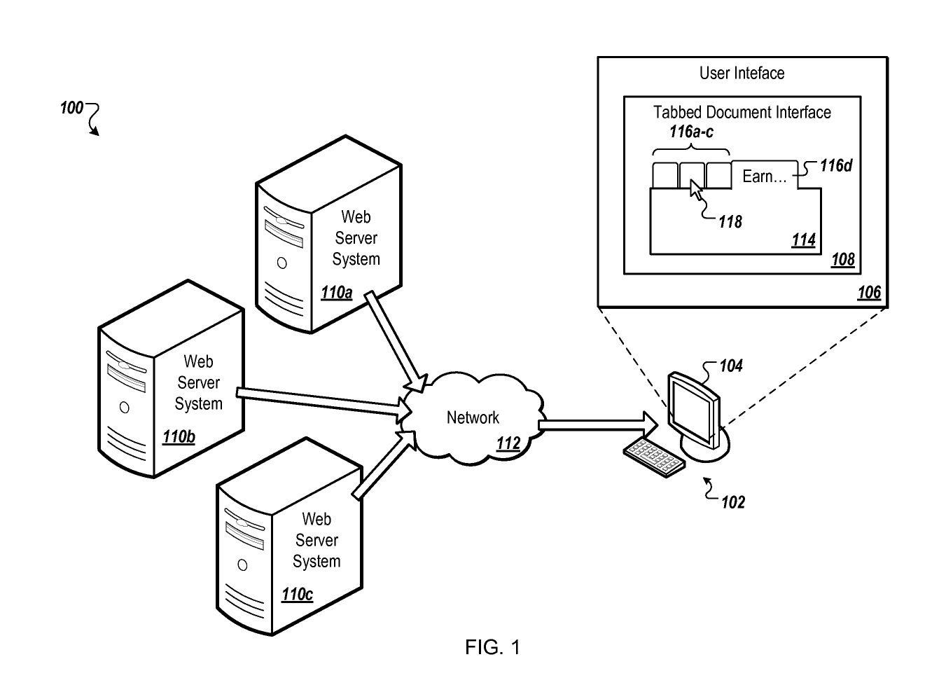

FIG. 1 is a schematic diagram that shows an example of a system 100 for managing tabs in a graphical user interface. The system 100 includes a computing device 102 that has a display device 104. The display device 104 presents a user interface 106 of one or more applications in operation at the computing device 102. The user interface 106 includes a tabbed document interface 108 for presenting multiple sets of information within the user interface 106.

For example, the tabbed document interface 108 can present multiple word processing documents in a user interface of a word processing application. In another example, the computing device 102 can receive multiple web pages from one or more web server systems 110a-c over a network 112. The tabbed document interface 108 can then present the multiple web pages in a user interface of a web browser application. In yet another example, the tabbed document interface 108 can present information other than documents, such as multiple sets of configuration settings in a configuration settings dialog window.

Each document, web page, or other item can be associated with one of multiple tabs 116a-d in the tabbed document interface 108. While shown here as including four tabs, the tabbed document interface 108 can include more or fewer tabs. In addition, over time tabs can be added to and/or removed from the tabbed document interface 108, for example, as a user makes inputs that open and/or close documents or pages.

A user can request presentation of a particular item in a presentation area 114 of the tabbed document interface 108 by making an input on the tab 116d associated with the item. The input on the tab 116d activates the item associated with the tab 116d in the presentation area 114. For example, a user can make an input with a pointing device on the tab 116d, such as a mouse click, that activates a document associated with the tab 116d in the presentation area 114. In another example, a user can make an input on the tab 116d using a keyboard or touch interface that activates the associated item in the presentation area 114.

In addition to activating an item, the tabbed document interface 108 can receive a user input that selects at least one of the tabs 116a-d for expansion, such as by hovering a pointer 118 over the selected tab or set of tabs. In some implementations, a user input (e.g., a mouse click) that activates an item associated with a tab also selects the tab for expansion.

A user input that requests expansion of a tab can include a passive input. For example, the passive input can include hovering the pointer 118 over the tab for a threshold amount of time. In some implementations, the tabbed document interface 108 expands the selected tab or set of tabs without activating an associated document or page in the presentation area 114, such as where the input is a passive input requesting expansion of the tab or set of tabs.

The user input requesting expansion of the tab or set of tabs can include an active input. For example, the active input can include clicking a button, tapping a touch surface, or pressing a key while the pointer 118 is over a tab or set of tabs. In some implementations, a user input that includes the active input makes the document associated with the selected tab or set of tabs active in the presentation area 114 in addition to expanding the selected tab or set of tabs.

The tabbed document interface 108 can expand the selected tab or set of tabs substantially in place. For example, the center of the selected tab or set of tabs may remain in the same position before and after the expansion. In another example, the space occupied by the selected tab or set of tabs before and after the expansion may overlap. Where the pointer 118 was used to select the tab or set of tabs, the tabbed document interface 108 can expand the selected tab or set of tabs so that the selected tab or set of tabs remains under the position of the pointer 118 after the expansion.

While examples described herein make reference to a pointer provided by a pointing device, other user input devices can be used. A user can, for example, make inputs using a keyboard, such as a first key combination to enter or begin selection of the tabs 116a-d, additional key presses to navigate through the tabs 116a-d (e.g., arrow keys), and a key press to activate a document associated with a tab or request expansion of a tab or set of tabs (e.g., an enter key). The tabbed document interface 108 can highlight the selected tab or set of tabs to indicate that the user has made one or more inputs using a device other than a pointing device to request activation of a document and/or expansion of a tab or set of tabs.

In expanding a tab or set of tabs, the tabbed document interface 108 expands a dimension of the tab or each tab in the set of tabs, such as a width and/or height of the tab. Each of the tabs 116a-d may have a same size when in an expanded state. For example, the dimension of each expanded tab can have a predetermined pixel width or percentage of the space available for the tabs 116a-d. In some implementations, the tabbed document interface 108 displays the change between a reduced state and an expanded state as an animation that gradually and/or smoothly transitions from one size of the dimension to the next.

Conversely, the tabbed document interface 108 can reduce or collapse a dimension of one or more tabs that were not selected for expansion. For example, the tabbed document interface 108 can distribute an amount of reduction across one or more tabs that were not selected that corresponds to an amount by which the selected tabs were expanded. In another example, the tabbed document interface 108 can expand the selected tabs to an expanded state and collapse the tabs that were not selected to a collapsed state.

In some implementations, the tabbed document interface 108 can include a user interface control for accessing a menu that lists each of the reduced and/or collapsed tabs. The tabbed document interface 108 can receive a user input that selects the user interface control. In response, the tabbed document interface 108 presents the menu including the list of reduced and/or collapsed tabs. The tabbed document interface 108 can then receive a user input that selects a reduced and/or collapsed tab from the list. In response, the tabbed document interface 108 can then activate the selected tab in the presentation area 114 and/or expand the dimension of the selected tab.

Each of the tabs 116a-d can include text, symbols, and/or icons that represent the associated items, such as a name of an associated document or web page, and/or an image for an associated document or web page. In some implementations, when expanding a tab or set of tabs, the tabbed document interface 108 expands the dimension of the tab or each tab in the set of tabs to accommodate the text, symbols, and/or icons included in the tab. For example, the tabbed document interface 108 can receive a user input requesting expansion of the tab 116d, and in response, expands the tab 116d so that it displays the full document title “Earnings Report” instead of the document title “Earn . . . ” that was truncated due to the reduced size of the tab 116d.

In addition, the tabbed document interface 108 may have a maximum size for the dimension. For example, the tabbed document interface 108 can limit the expansion of the dimension to a maximum number of characters, pixels, or other measurement of length for the text, symbols, and/or icons included in the tab. In another example, the tabbed document interface 108 can limit the expansion of the dimension to a relative amount, such as a percentage of the space available for the tabs 116a-d.

The dimension of one or more tabs may remain fixed (e.g., in a reduced state and/or an expanded state) while other tabs are expanded and/or reduced. For example, the fixed tabs can include a particular number of tabs, such as about ten tabs. The fixed tabs can be based on an analysis of the documents or pages accessed most by the user, with the most accessed being included in the set of fixed tabs. In some implementations, the user can make an input to explicitly request that one or more particular documents or pages be included in the set of fixed tabs (e.g., by “pinning” the tab to the set of fixed tabs).

The number of fixed tabs can be based on the amount of space available for the tabs 116a-d. For example, the fixed tabs may occupy a particular percentage of the space available, such as about 85% of the space available for the tabs 116a-d. The tabbed document interface 108 can place the fixed tabs on the left end or beginning of a list of the tabs 116a-d. Alternatively, the tabbed document interface 108 can leave each fixed tab at the position in which the tab was identified as fixed (e.g., by a user pinning input or by usage analysis).

In some implementations, the tabbed document interface 108 includes a fixed or limited amount of space for the tabs. As tabs are added, removed, and/or changed in size, the tabbed document interface 108 manages the use of the space that is available for the tabs 116a-d. The tabbed document interface 108 follows one or more rules to determine how to divide the available space up among the tabs for the items that are currently available for access within the tabbed document interface 108. The rules can include, for example, a stack style, that expands a dimension of at least one tab and reduces or collapses a dimension of another tab.

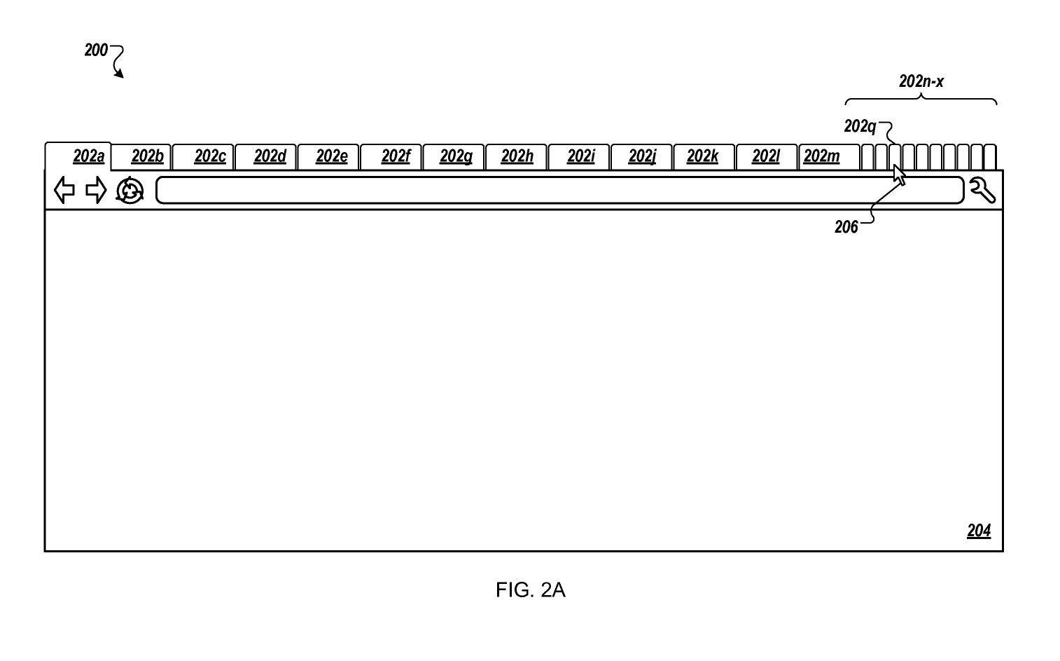

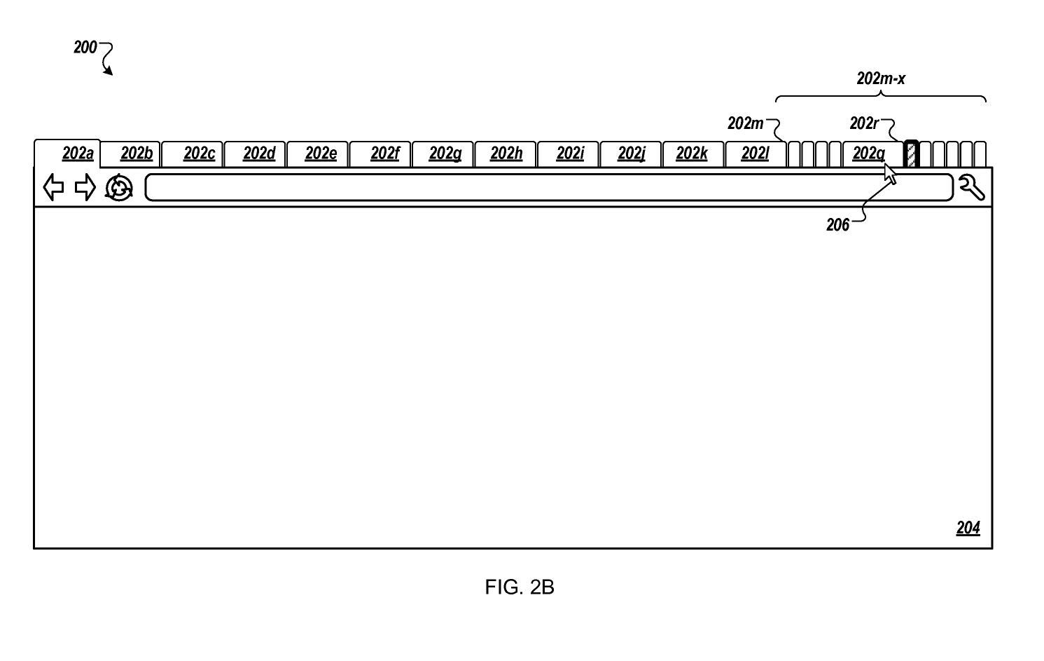

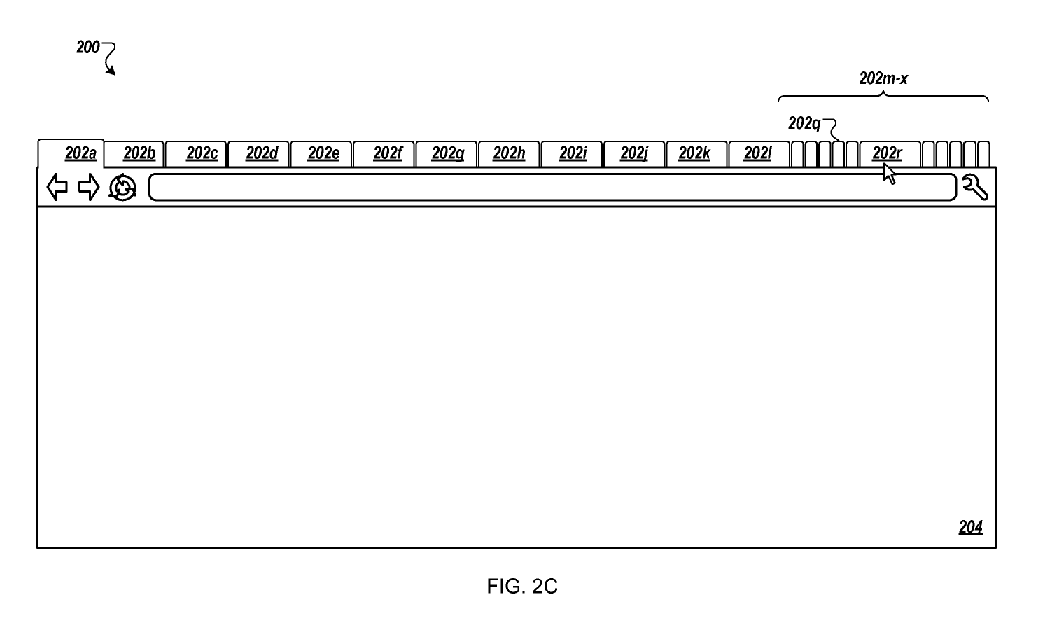

FIGS. 2A-C show examples of a graphical user interface for managing tabs in a graphical user interface using a stack style. FIG. 2A shows an example of a stack style GUI 200 in an initial state. The stack style GUI 200 includes multiple tabs 202a-x. The tabs 202a-m at left side of the stack style GUI 200 are expanded and the tabs 202n-x at the right side of the stack style GUI 200 are collapsed.

The tabs 202a-l remain fixed as expanded while others of the tabs 202m-x expand and collapse. While, the example shown in FIG. 2A includes twelve fixed tabs, the stack style GUI 200 can include more or fewer fixed tabs. The stack style GUI 200 can, for example, receive user inputs requesting that tabs be fixed in size. In another example, the stack style GUI 200 can analyze the usage of tabs to identify a number of tabs that are used most frequently as fixed tabs, such as about ten of the most frequent tabs or a number of the most frequently used tabs that occupy about 75% percent of the space available for the tabs. The stack style GUI 200 can place the fixed tabs on the left end or beginning of a list of the tabs 202a-x. Alternatively, the stack style GUI 200 can leave each fixed tab at the position in which the tab was identified as fixed (e.g., by a user pinning input or by usage analysis).

The tabs 202m-x that are collapsible occupy the remainder of the space at the right side of the stack style GUI 200. A user can make an input using a pointer 206 that selects the tab 202q, which is currently collapsed, to request that the stack style GUI 200 expand the tab 202q that was selected.

FIG. 2B shows an example of the stack style GUI 200 after having expanded a collapsed tab. In response to a user input on the tab 202q that was collapsed, the stack style GUI 200 expands the tab 202q. The stack style GUI 200 can collapse another tab to accommodate the expansion of the tab 202q that was collapsed. For example, the stack style GUI 200 can collapse the tab 202m at the left end of the tabs 202m-x that are collapsible.

The stack style GUI 200 does not collapse the tabs 202a-l that are fixed as expanded while accommodating expansion of the collapsible tabs. However, in some implementations, the stack style GUI 200 can reduce the size of the tabs 202a-l that are fixed as expanded (e.g., without reaching a completely collapsed state) to accommodate expansion of the collapsible tabs.

The stack style GUI 200 can receive one or more user inputs from a device other than a pointing device, such as a keyboard. For example, a first key combination can be used to enter the tabs 202a-x, additional key presses can navigate through the tabs 202a-x (e.g., arrow keys), and a key press to activate a document associated with a tab (e.g., an enter key) in a presentation area 204. The tab 202r is highlighted to indicate that the user has made one or more inputs using a device other than a pointing device to request expansion of the tab 202r.

FIG. 2C shows an example of the stack style GUI 200 after having expanded an additional collapsed tab. The stack style GUI 200 has, in response to the one or more inputs from the user, expanded the tab 202r that was previously collapsed and has collapsed the tab 202q that was previously expanded. In some implementations, the stack style GUI 200 only allows the user to expand a fixed number of the set of collapsible tabs (e.g., one tab) at one time. For example, if the user hovers the pointer 206 over a collapsed tab among the tabs 202m-x that are collapsible for the threshold amount of time, then the stack style GUI 200 can expand each collapsed tab as the user hovers the pointer 206 over the particular collapsed tab. Accordingly, the stack style GUI 200 collapses the collapsible tab that the pointer 206 was previously hovering over.

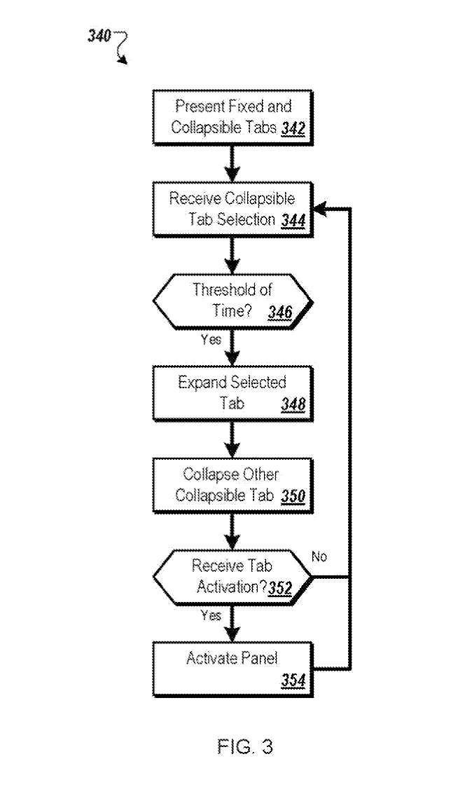

FIG. 3 is a flow chart that shows an example of a process 340 for managing tabs in a graphical user interface using a stack style. The process 340 may be performed, for example, by a system such as the system 100 and the stack style GUI 200. For clarity of presentation, the description that follows uses the system 100 and the stack style GUI 200 as examples for describing the process 340. However, another system, or combination of systems, may be used to perform the process 340.

The process 340 begins with presenting (342) multiple collapsible tabs in a tab area of a tabbed interface. The process 340 can also present one or more fixed or non-collapsible tabs in the tab area that remain in the expanded state. The process 340 can arrange the multiple collapsible tabs (and any non-collapsible tabs) horizontally in the tab area of the tabbed interface. The process 340 can present the multiple collapsible tabs as a first contiguous group of tabs in the tab area and the one or more non-collapsible tabs as a second contiguous group of tabs in the tab area. For example, the computing device 102 can present the tabs 202a-l as a group of non-collapsible tabs and the tabs 202m-x as a group of collapsible tabs in the stack style GUI 200 on the display device 104.

The process 340 receives (344) a user input that selects a first tab from among the multiple collapsible tabs. The first tab is in a collapsed state. The multiple collapsible tabs also include a second tab that is in an expanded state. In addition, the user input occurs for at least a threshold amount of time. The user input can include a hover operation of a pointer provided by a pointing device. For example, a user can operate a pointing device at the computing device 102 to hover the pointer 206 over a collapsed tab, such as the tab 202q, as shown in FIG. 2A, for at least a threshold amount of time.

If the process 340 determines that the user input occurs for at least a threshold amount of time, then the process 340 expands (348) the first tab to the expanded state. The process 340 also collapses (350) the second tab to the collapsed state in response to determining that the first user input occurs for at least the threshold amount of time. For example, in response to hovering the pointer 206 over the tab 202q, the computing device 102 expands the tab 202q and collapses the tab 202m, as shown in FIG. 2B. In some implementations, the process 340 only collapses a currently expanded collapsible tab in response to a request to expand a collapsed tab, without collapsing or reducing a dimension of others of the collapsible and/or non-collapsible tabs.

If the process 340 receives (352) a user input that activates the first tab, then the process 340 can activate (354) a panel associated with the first tab in response to receiving the user input that activates the first tab. The user input that activates the first tab can be separate from and of a different type than the user input that selects the first tab for expansion. For example, the computing device 102 can receive a hover operation with the pointer 206 to select the tab 202q and a click operation with the pointer 206 to activate a document associated with the tab 202q in the presentation area 204. The process 340 can receive a user input that both selects a tab for expansion and activates a document associated with the tab in a presentation area.

The process 340 can receive (344) another user input that selects another collapsible tab for expansion. If the process 340 determines that the pointer remains in the tab area between receiving a previous user input that selected a collapsible tab for expansion and receiving a subsequent user input that selects a subsequent collapsible tab for expansion, then the process 340 can use a reduced threshold amount of time to trigger expansion of the subsequent collapsible tab. For example, after expanding the tab 202q and receiving a user input that moves the pointer 206 to the tab 202r without leaving the tab area in the stack style GUI 200, the computing device 102 can expand the tab 202r immediately upon the pointer 206 entering the tab 202r. Alternatively, the computing device 102 can expand the tab 202r after the pointer 206 hovers over the tab 202r for a threshold amount of time that is less than the threshold amount of time by which the pointer 206 hovered over the tab 202q. For example, the initial threshold can be one second and the subsequent threshold can be one half of a second.

If the process 340 determines that the pointer leaves the tab area between receiving a previous user input that selected a collapsible tab for expansion and receiving a subsequent user input that selects a subsequent collapsible tab for expansion, then the process 340 can use the initial threshold amount of time to trigger expansion of the subsequent collapsible tab. For example, after expanding the tab 202q and receiving a user input that moves the pointer 206 to the tab 202r by first leaving the tab area, the computing device 102 expands the tab 202r after the pointer 206 has hovered over the tab 202r for the initial threshold amount of time and not the reduced threshold amount of time.

After any collapsing of the multiple collapsible tabs, the process 340 can display at least a portion of each of the multiple collapsible tabs (and any non-collapsible tabs) in the tab area of the tabbed interface. For example, the computing device 102 can collapse one or more of the tabs 202m-x without completely hiding any of the tabs 202m-x. In addition, the process 340 can collapse a previously expanded collapsible tab by a same amount that another collapsible tab is currently being expanded. The process 340 can slide one or more of the multiple collapsible tabs horizontally to accommodate collapsing a collapsible tab and expanding another collapsible tab.

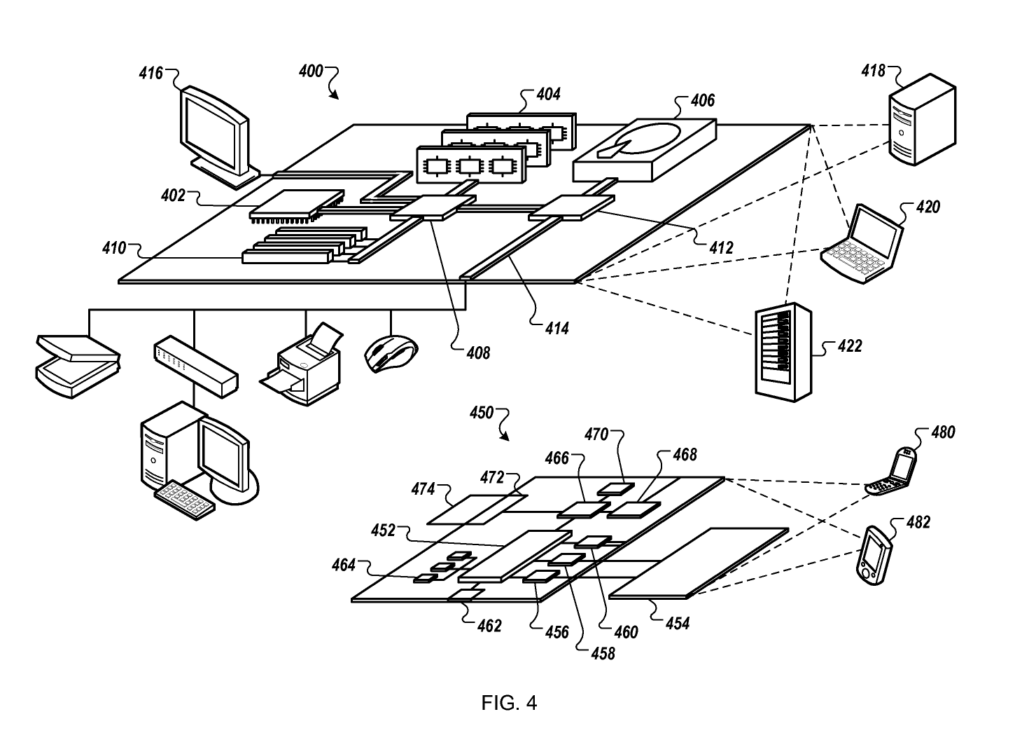

FIG. 4 is a schematic diagram that shows an example of a computing device 400 and an example of a mobile computing device that can be used to implement the systems and techniques described here. The computing device 400 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations.

A computer program product can be tangibly embodied in an information carrier. The computer program product may contain instructions that, when executed, perform one or more methods, such as those described above. The computer program product can also be tangibly embodied in a computer- or machine-readable medium, such as the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is exemplary only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 418, or multiple times in a group of such servers. In addition, it may be implemented in a personal computer such as a laptop computer 420. It may also be implemented as part of a rack server system 422. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. The memory 464 may include, for example, flash memory and/or NVRAM memory (non-volatile random access memory).

An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a secure manner.

In some implementations, a computer program product is tangibly embodied in an information carrier. The computer program product contains instructions that, when executed, perform one or more methods, such as those described above. The computer program product can be a computer- or machine-readable medium, such as the memory 464, the expansion memory 474, or memory on the processor 452. In some implementations, the computer program product can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A computer-implemented method for managing tabs in a graphical user interface, the method comprising:
receiving a first user input that selects a first tab from among multiple collapsible tabs in a tab area of a tabbed interface;
determining that the first user input occurs for at least a threshold amount of time;
expanding the first tab from a collapsed state to an expanded state in response to determining that the first user input occurs for at least the threshold amount of time;
collapsing a second tab, from among the multiple collapsible tabs, from the expanded state to the collapsed state in response to determining that the first user input occurs for at least the threshold amount of time; and
providing one or more fixed tabs, which are separate from the multiple collapsible tabs, in the tab area based on user information, each fixed tab maintaining one of a collapsed state or an expanded state.

2. The method of claim 1, wherein the first user input comprises a hover operation of a pointer provided by a pointing device.

3. The method of claim 1, further comprising:
receiving a second user input that selects a third tab from among the multiple collapsible tabs after receiving the first user input, wherein the second user input occurs for less than the threshold amount of time, wherein the pointer remains in the tab area between receiving the first user input and receiving the second user input, and wherein the second user input comprises the hover operation;
expanding the third tab from the collapsed state to the expanded state in response to receiving the second user input; and
collapsing the first tab from the expanded state to the collapsed state in response to receiving the second user input.

4. The method of claim 3, further comprising:
receiving a third user input that selects a fourth tab from among the multiple collapsible tabs after receiving the second user input, wherein the pointer leaves the tab area between receiving the second user input and receiving the third user input, and wherein the third user input comprises the hover operation;
determining that the third user input occurs for at least the threshold amount of time;
expanding the fourth tab from the collapsed state to the expanded state in response to determining that the third user input occurs for at least the threshold amount of time; and
collapsing the third tab from the expanded state to the collapsed state in response to determining that the third user input occurs for at least the threshold amount of time.

5. The method of claim 1, wherein at least a portion of each of the multiple collapsible tabs is displayed in the tab area of the tabbed interface.

6. The method of claim 1, wherein collapsing the second tab occurs without collapsing the multiple collapsible tabs other than the second tab.

7. The method of claim 1, wherein the multiple collapsible tabs are arranged horizontally and the method further comprises sliding one or more of the multiple collapsible tabs horizontally to accommodate collapsing the second tab and expanding the first tab.

8. (canceled)

9. The method of claim 1, wherein the multiple collapsible tabs form a first contiguous group of tabs in the tab area and the one or more non-collapsible tabs form a second contiguous group of tabs in the tab area.

10. The method of claim 1, further comprising:
receiving a fourth user input that activates the first tab while the first tab is in the expanded state, wherein the fourth user input is separate from and of a different type than the first user input; and
activating a panel associated with the first tab in response to receiving the fourth user input.

11. A computer-readable medium storing instructions that when executed cause a computer to perform operations for managing tabs in a graphical user interface, the operations comprising:
receiving a first user input that selects a first tab from among multiple collapsible tabs in a tab area of a tabbed interface;
determining that the first user input occurs for at least a threshold amount of time;
expanding the first tab from a collapsed state to an expanded state in response to determining that the first user input occurs for at least the threshold amount of time;
collapsing a second tab, from among the multiple collapsible tabs, from the expanded state to the collapsed state in response to determining that the first user input occurs for at least the threshold amount of time; and
providing one or more fixed tabs, which are separate from the multiple collapsible tabs, in the tab area based on the amount of space available for the multiple collapsible tabs, each fixed tab maintaining one of a collapsed state or an expanded state.

12. The computer-readable medium of claim 11, wherein the first user input comprises a hover operation of a pointer provided by a pointing device.

13. The computer-readable medium of claim 12, wherein at least a portion of each of the multiple collapsible tabs is displayed in the tab area of the tabbed interface.

14. The computer-readable medium of claim 13, wherein the operations further comprise:
receiving a second user input that selects a third tab from among the multiple collapsible tabs after receiving the first user input, wherein the second user input occurs for less than the threshold amount of time, wherein the pointer remains in the tab area between receiving the first user input and receiving the second user input, and wherein the second user input comprises the hover operation;
expanding the third tab from the collapsed state to the expanded state in response to receiving the second user input; and
collapsing the first tab from the expanded state to the collapsed state in response to receiving the second user input.

15. The computer-readable medium of claim 14, wherein the operations further comprise:
receiving a third user input that selects a fourth tab from among the multiple collapsible tabs after receiving the second user input, wherein the pointer leaves the tab area between receiving the second user input and receiving the third user input, and wherein the third user input comprises the hover operation;
determining that the third user input occurs for at least the threshold amount of time;
expanding the fourth tab from the collapsed state to the expanded state in response to determining that the third user input occurs for at least the threshold amount of time; and
collapsing the third tab from the expanded state to the collapsed state in response to determining that the third user input occurs for at least the threshold amount of time.

16. The computer-readable medium of claim 14, wherein collapsing the first tab occurs without collapsing the multiple collapsible tabs other than the first tab.

17. The computer-readable medium of claim 14, wherein the multiple collapsible tabs are arranged horizontally and the operations further comprise sliding one or more of the multiple collapsible tabs horizontally to accommodate collapsing the first tab and expanding the third tab.

18. (canceled)

19. The computer-readable medium of claim 11, wherein the multiple collapsible tabs form a first contiguous group of tabs in the tab area and the one or more non-collapsible tabs form a second contiguous group of tabs in the tab area.

20. The computer-readable medium of claim 11, wherein the operations further comprise:
receiving a fourth user input that activates the first tab while the first tab is in the expanded state, wherein the fourth user input is separate from and of a different type than the first user input; and
activating a panel associated with the first tab in response to receiving the fourth user input.

21. A computer-implemented system for managing tabs in a graphical user interface, the system comprising:
a display device that presents multiple collapsible tabs, including at least a first tab and a second tab, in a tab area of a tabbed interface;
an interface that receives a first user input that selects the first tab;
one or more processors that determine that the first user input occurs for at least a threshold amount of time and, in response, expand the first tab from a collapsed state to an expanded state and collapse the second tab from the expanded state to the collapsed state; and
one or more processors that determine that one or more tabs should be fixed tabs that are separate from the multiple collapsible tabs, each fixed tab maintaining one of a collapsed state or an expanded state, and in response, provide each determined tab as a fixed tab in the position the determined tab was in when the determination was made.

22. The method of claim 1, wherein the providing one or more fixed tabs further comprises:
receiving a user request that one or more tabs associated with particular documents or pages be provided as fixed tabs; and
providing the requested tabs as fixed tabs.

23. The method of claim 1, wherein the providing one or more fixed tabs further comprises:
analyzing the documents or pages most accessed by a user; and
providing tabs associated with one or more of the most accessed documents or pages as fixed tabs.
